(19) United States
(12) Patent Application Publication
(10) Pub. No.: US 2007/0087125 A1
(43) Pub. Date: Apr. 19, 2007

(54) Process for producing top coat film used in lithography

(75) Inventors: Kazuhiko Maeda, Hino-shi (JP); Michitaka Ootani, Fujimino-shi (JP); Haruhiko Komoriya, Iruma-gun (JP)

Correspondence Address: CROWELL & MORING LLP;INTELLECTUAL PROPERTY GROUP, P.O. BOX 14300, WASHINGTON, DC, 20044-4300, US

(73) Assignee: Central Glass Company, Limited., Ube-shi (JP)

(21) Appl. No.: 11/249,603

(22) Filed: Oct. 14, 2005

(51) Int. Cl. B05D 1/18; B05D 7/00

(52) U.S. Cl. 427/402; 427/430.1

(57) ABSTRACT

The present invention relates to a process for producing a top coat film used in a lithography. This process includes the steps of (a) providing a polymer that dissolves in an alkali developing solution, the polymer having in the molecule at least one group that is optionally protected and that is selected from the group consisting of a fluorocarbinol group, a sulfonic group, a fluoroalkylsulfonic group, and a carboxylic group; (b) dissolving the polymer in an organic solvent containing 40 wt % or greater of an alkane, thereby preparing a coating composition; and (c) applying the coating composition to a photoresist film, thereby forming the top coat film on the photoresist film.

### BACKGROUND OF THE INVENTION

The present invention relates to a fluorine-containing polymer containing a fluorine-containing structure and a process for producing a top coat film that is used in a lithography and is obtained by using a coating composition containing a particular organic solvent.

Fluorine-containing compounds are developed or used in wide applied fields of advanced materials, due to characteristics possessed by fluorine, such as water repellency, oil repellency, low water absorption, heat resistance, weatherability, corrosion resistance, transparency, photosensitivity, low refractive index, and low dielectric property. In particular, resist materials of fluorine-containing compounds have recently and actively been studied as novel materials that are highly transparent to short wavelength ultraviolet rays, such as F₂ and ArF. A common molecular design in these applied fields is based on the achievement of various performances such as transparency at each used wavelength due to the introduction of fluorine, photosensitivity using acid characteristics of fluoroalcohols such as hexafluoroisopropanol (hexafluorocarbinol), adhesion to substrate, and high hardness, that is, glass transition point (Tg).

Recently, immersion lithography has rapidly emerged as a lithography for producing next-generation semiconductors. In particular, the entire business circle pays attention to it as a means for prolonging the lifetime of exposure technique by ArF excimer laser. In this case, liquid (e.g., water) is brought into contact with the photoresist surface. Therefore, how various problems, such as resist swelling, liquid penetration into the resist, and compound elution from the resist, are solved has become an important factor to improve the immersion lithography performance.

As a solving means, there is reported a process of coating the photoresist surface with a top coat (see Resist and Cover Material Investigation for Immersion Lithography, 2nd Immersion Work Shop, Jul. 11, 2003). For example, however, it becomes deficient in solubility in developing solution. Thus, it has not reached the level at which the material is optimized. The top coat is a polymer protective film and therefore may be referred to as cover coat.

### SUMMARY OF THE INVENTION

There is a demand for a measure to intercept the environment or water from a resist film by coating the resist film with the coating film, of which both exposed portion and non-exposed portion are dissolved in a developing solution in a short period of time at similar rates.

In the case of normal dry lithography, it is requested to protect the resist film from chemical substances such as amine of the environment, and a top coat that can be applied without corroding the resist film and is dissolved in alkali developing solution is becoming important. In the case of the immersion lithography, there has been a demand for a process for producing a top coat film that simultaneously satisfies performances such as less swelling and less dissolution in water and the capability of adjusting refractive index of the film, in addition to the demand in the case of dry.

According to the present invention, there is provided a process for producing a top coat film used in a lithography. This process comprises the steps of:

(a) providing a polymer that dissolves in an alkali developing solution, the polymer having in the molecule at least one group that is optionally protected and that is selected from the group consisting of a fluorocarbinol group, a sulfonic group, a fluoroalkylsulfonic group, and a carboxylic group;

(b) dissolving the polymer in an organic solvent containing 40 wt % or greater of an alkane, thereby preparing a coating composition; and

(c) applying the coating composition to a photoresist film, thereby forming the top coat film on the photoresist film.

### DETAILED DESCRIPTION

The above process for producing a top coat film according to the present invention, which was found as a result of a repeated eager examination to solve the above task, may be a process for producing a top coat film, in which a composition obtained by dissolving in a particular alkane organic solvent a fluorine-containing polymer that has a structure having a particular fluoroalcohol group in the same monomer and that is soluble in alkali developing solution is applied to a photoresist film. It was also found that the present invention can be used in normal dry lithography as well as immersion lithography.

The present invention can provide a novel process for producing a top coat film using a coating composition in which a polymer having an acid group such as fluorocarbinol group, sulfonic acid group or carboxylic group has been dissolved in a specific alkane organic solvent that does not dissolve a photoresist film. By using the present process, it is possible to obtain a rectangular pattern, without an increase of the apparent film pressure of the resist film, without swelling of the resist film, and without T-top pattern configuration. The present process can be used for dry or immersion lithography under a preferable condition, irrespective of the type of the resist film as an underlayer.

In the following, embodiments of the present invention are described in detail. The present invention provides a process for producing a top coat film used in a lithography, in which a fluorine-containing polymer that has in the molecule at least one acid group that is optionally protected and that is selected from a fluorocarbinol group, a sulfonic acid group, a fluoroalkylsulfonic acid group, and a carboxylic group and that dissolves in an alkali developing solution is dissolved in an organic solvent containing 40 wt % or greater of an alkane hydrocarbon solvent, followed by application to a photoresist film prior to exposure.

As the acid group usable in the present invention, such as fluorocarbinol group, sulfonic acid group, fluoroalkylsulfonic acid group and carboxylic group, it is possible to use one that is attached to a main chain directly or via a chain or cyclic bond. It is used without limitation in structure.

Specific examples of the structure of a terminal acid site contained in an acid group usable are as follows. In the following structure, Rf represents a fluoroalkyl group.

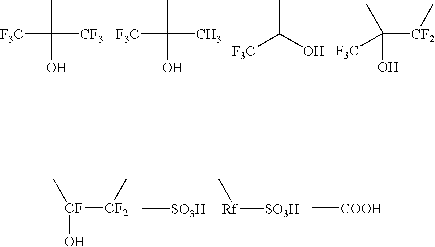

To provide a polymer of the present invention with an acid group, there is used a process in which it is previously introduced into a monomer to be polymerized, or a process in which a polymer after polymerization is provided with an acid group by a polymer reaction. That is, it becomes soluble by the effect of the above-mentioned acid group in an alkali aqueous solution, such as tetramethylammonium hydroxide aqueous solution, which is used in a normal photoresist development process. On the other hand, it becomes soluble in an organic solvent containing an alkane as a main component by synergy of the fluorine content of a suitable amount and an acid group.

Thus, as specific examples of a monomer containing an acid group usable in the present invention, there are cited monomers that are represented by the following structures and have polymerizable unsaturated bonds.

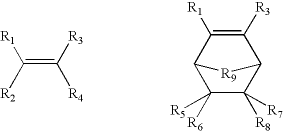

Herein, at least one of R₁ to R₉ is a group containing directly or indirectly one or a plurality of acid groups that are optionally protected. In the case of having an acid group indirectly, it can arbitrarily contain a link structure such as alkylene, aliphatic ring, aromatic ring, ether, ester and carbonyl. Furthermore, it may contain fluorine, chlorine, cyano group, alkyl group, fluoroalkyl group and the like. R₁ to R₉, except the functional group containing an acid group, are not particularly limited. They may be hydrogen, fluorine, chlorine, cyano group, alkyl group, fluoroalkyl group, cyclic group, unsaturated bond group and the like. These may indirectly be contained through an extension group such as ether, ester, and alkylene.

On the other hand, as monomers that are copolymerizable with the acid group-containing monomers, it is possible to use olefin, fluoroolefin, acrylic ester, methacrylic ester, fluorine-containing acrylic ester or methacrylic ester, fluoroether, norbornene, a norbornene containing fluorine at side chain, and other polymerizable monomers. As special examples, it is possible to use a fluorine-containing polymer having fluoroalkylsulfonic acid at side chain, which is known by an ordinary name of Nafion film, and a fluorine-containing polymer that forms a ring during the polymerization process.

Examples of the olefin usable in the present invention are ethylene, propylene and the like. Those of the fluoroolefin are vinyl fluoride, vinylidene fluoride, trifluoroethylene, chlorotrifluoroethylene, tetrafluoroethylene, hexafluoropropylene, hexafluoroisobutene, octafluorocyclopentene, and the like.

The acrylic ester or methacrylic ester can be used without particular limitation with respect to ester side chain. As known compounds are exemplified, it is possible to use alkyl esters of acrylic acid or methacrylic acid such as methyl acrylate or methacrylate, ethyl acrylate or methacrylate, n-propyl acrylate or methacrylate, isopropyl acrylate or methacrylate, n-butyl acrylate or methacrylate, isobutyl acrylate or methacrylate, n-hexyl acrylate or methacrylate, n-octyl acrylate or methacrylate, 2-ethylehexyl acrylate or methacrylate, lauryl acrylate or methacrylate, 2-hydroxyethyl acrylate or methacrylate, and 2-hydroxypropyl acrylate or methacrylate; acrylates or methacrylates containing ethylene glycol, propylene glycol and tetramethylene glycol groups; unsaturated amides such as acrylamide, methacrylamide, N-methylolacrylamide, N-methylolmethacylamide, and diacetoneacrylamide; acrylonitrile, methacrylonitrile, alkoxysilane-containing vinyl silane, acrylic or methacrylic esters, t-butyl acrylate or methacylate, 3-oxocyclohexyl acrylate or methacrylate, adamantyl acrylate or methacrylate, alkyladamantyl acrylate or methacrylate, cyclopentyl or cyclohexyl acrylate or methacrylate, one or two hydroxyl groups-containing cyclopentyl or cyclohexyl acrylate or methacrylate, one or two hydroxyl groups-containing adamantylacrylate or methacrylate, tricyclodecanyl acrylate or methacrylate, an acrylate or methacrylate having a special lactone ring having a norbornane ring and a lactone ring at the same time, an acrylate or methacrylate in which a norbornane ring has directly or indirectly been esterified, acrylic acid, methacrylic acid, acrylamide, methacrylonitrile, methacrylamide, and the like. The above-mentioned cyclic acrylate or methacrylate may be a primary, secondary or tertiary ester. Furthermore, it is also possible to use an acrylate, methacrylate, norbornene, styrene or the like of a structure having one hexafluorocarbinol group at side chain. Furthermore, it is also possible to use an acrylate, methacrylate, norbornene or styrene having sulfonic acid, carboxylic acid, hydroxyl group or cyano group at side chain. Furthermore, it is possible to copolymerize the above-mentioned acrylate compounds containing an α cyano group and their analogous compounds such as maleic acid, fumaric acid, and maleic anhydride.

In particular, there is preferably used a process to conduct a copolymerization with acrylonitrile for the purpose of adjusting the refractive index to an arbitrary value by an combination with low refractive index of fluorine.

There is also preferably used a monomer represented by a general formula obtained by an esterification using one or two alcohols after a copolymerization with maleic anhydride.

The cyclic group can be used without particular limitation, as long as it contains a cyclic structure and fluorine.

The fluorine-containing acrylic ester or fluorine-containing methacrylic ester is an acrylic ester or methacrylic ester having a fluorine atom-containing group at acrylic α position or ester moiety. For example, as a monomer in which a fluorine-containing alkyl group has been introduced into α position, it is possible to use monomers in which trifluoromethyl group, trifluoroethyl group, nonafluoro-n-butyl group, and the like are provided at α position of the above-mentioned non-fluoro acrylic ester or methacrylic ester. On the other hand, they are acrylic esters or methacrylic esters having perfluoroalkyl group and fluorine-containing alkyl group, which are obtained by partly or entirely replacing the ester moiety with fluorine, and a unit where a cyclic structure and fluorine are coexistent in ester moiety, the cyclic structure being a unit having a fluorine-containing benzene ring, fluorine-containing cyclopentane ring, fluorine-containing cyclohexane ring, fluorine-containing cycloheptane ring or the like, in which fluorine or trifluoromethyl group has been substituted. It is also possible to use an acrylic or methacrylic ester in which the ester moiety is a fluorine-containing t-butyl ester group. In exemplifying particularly representative ones of such units in the form of monomer, there are cited 2,2,2-trifluoroethylacrylate, 2,2,3,3-tetrafluoropropylacrylate, 1,1,1,3,3,3-hexafluoroisopropylacrylate, heptafluoroisopropylacrylate, 1,1-dihydroheptafluoro-n-butylacrylate, 1,1,5-trihydrooctafluoro-n-pentylacrylate, 1,1,2,2-tetrahydrotridecafluoro-n-octylacrylate, 1,1,2,2-tetrahydroheptadecafluoro-n-decylacrylate, 2,2,2-trifluoroethylmethacrylate, 2,2,3,3-tetrafluoropropylmethacrylate, 1,1,1,3,3,3-hexafluoroisopropylmethacrylate, heptafluoroisopropylmethacrylate, 1,1- dihydroheptafluoro-n-butylmethacrylate, 1,1,5-trihydrooctafluoro-n-pentylmethacrylate, 1,1,2,2-tetrahydrotridecafluoro-n-octylmethacrylate, 1,1,2,2-tetrahydroheptadecafluoro-n-decylmethacrylate, perfluorocyclohexylmethylacrylate, perfluorocyclohexylmethylmethacrylate, and the like. Furthermore, it is possible to use a monomer that has a trifluoro or hexafluorocarbinol group at a side chain terminal to have acidity or monomers protected with an acid-labile group or other functional groups, without limitation in structure.

The norbornene compounds and fluorine-containing norbornene compounds are norbornene monomers having a mononucleus or multinucleus structure. These can also be copolymerized without particular limitation. Oxonorbornene compounds are also preferably usable. As norbornene compounds usable herein are specifically described, they have one or more of polymerizable unsaturated bonds in the monomer molecule. It is possible to replace arbitrary hydrogens that are directly bonded to carbons with fluorine, chlorine, cyano group, alkyl group, alkylene group, alkoxy group, ester, ether, carboxyl group, hydroxyl group or other functional groups alone or in combination.

Furthermore, it is also possible to use styrene compounds, fluorine-containing styrene compounds, vinyl ethers, fluorine-containing vinyl ethers, allyl ethers, vinyl esters, vinyl silanes and the like. Here, as styrene compounds and fluorine-containing styrene compounds, it is possible to use a compound in which one or a plurality of hexafluorocarbinol groups are bonded, a styrene or hydroxystyrene in which trifluoromethyl group has been substituted for hydrogen, and the above styrene or fluorine-containing styrene compound in which halogen, alkyl group or fluorine-containing alkyl group has been attached to α position.

On the other hand, as the vinyl ethers and the fluorine-containing vinyl ethers, it is also possible to use an alkyl vinyl ether that optionally contains methyl group, ethyl group, or hydroxyl group such as hydroxyethyl group and hydroxybutyl group; cyclohexyl vinyl ether and a cyclic vinyl ether containing a hydrogen or carbonyl bond in its cyclic structure; a fluorine-containing vinyl ether in which fluorine has been substituted for hydrogen of unsaturated bond, perfluorovinyl ether, and the like. Allyl ethers, vinyl esters and vinyl silanes can also be used without particular limitation, as long as they are known compounds. Furthermore, of vinyl ether and allyl ether monomers, it is possible to use a monomer that has a trifluoro or hexafluorocarbinol group at a side chain terminal to have acidity or monomers protected with an acid-labile group or other functional groups, without limitation in structure.

These copolymerizable compounds may be used alone or in combination of at least two kinds.

The polymerization process of a polymer compound according to the present invention is not particularly limited, as long as it is a generally used process. It is preferably radical polymerization, ionic polymerization or the like. In some cases, it is possible to use coordinated anionic polymerization, living anionic polymerization or the like. Herein, a more general radical polymerization is explained. That is, it may be conducted by either of batch-wise, half continuous or continuous operation by a known polymerization method such as bulk polymerization, solution polymerization, suspension polymerization or emulsion polymerization in the presence of a radical polymerization initiator or radical initiating source.

The radical polymerization initiator is not particularly limited. As examples, azo compounds, peroxides and redox compounds are cited. In particular, preferable ones are azobisbutyronitrile, t-butylperoxypivalate, di-t-butylperoxide, i-butyrylperoxide, lauroylperoxide, succinic acid peroxide, dicinnamylperoxide, di-n-propylperoxydicarbonate, t-butylperoxyallyl monocarbonate, benzoyl peroxide, hydrogen peroxide, ammonium persulfate, and the like. It is possible to use an initiator containing a hydroxyl group, carboxyl group or sulfonic acid group at the terminal or an initiator in which fluorine has partially or fully been substituted therefor.

The reaction vessel for conducting the polymerization reaction is not particularly limited. It is optional to use a polymerization solvent in the polymerization reaction. Typical ones as the polymerization solvent are esters such as ethyl acetate and n-butyl acetate; ketones such as acetone and methyl isobutyl ketone; hydrocarbons such as toluene and cyclohexane; and alcohols such as isopropyl alcohol and ethylene glycol monomethyl ether. Furthermore, it is possible to use various solvents such as water, ethers, cyclic ethers, fluorohydrocarbons, and aromatics. These solvents can be used alone or in mixture of at least two kinds. Furthermore, it is also possible to use a molecular weight adjusting agent, such as mercaptan and chlorine-containing compounds. The temperature for conducting the copolymerization reaction is suitably changed depending on the radical polymerization initiator or radical polymerization initiating source. It is preferably 0-200° C., particularly preferably 30-140° C.

As number average molecular weight of the obtained polymer of the present invention, it is generally appropriately in a range of 1,000-100,000, preferably in a range of 2,000-20,000. It is preferable to set the molecular weight to 15,000 or less for the purpose of satisfying solubility in alkanes.

Since the fluorine content contained in the polymer compound improves solubility in alkanes, it is necessary to set the fluorine content to 20 wt % or greater. In the present invention, the obtained polymer is used by dissolving it in an organic solvent containing an alkane as a main component. As the organic solvent composition usable, there are used solvents that hardly corrode a resist film as the underlayer and hardly extract additives and the like from the resist film and that have a boiling point range suitable for spin coating, that is, about 70°C.-170° C.

According to the present invention, a mixing with a photoresist film of the underlayer during the top coat application step can be controlled to the minimum by using an organic solvent containing 40 wt % or greater of an alkane. To be more preferable, it is more effective to conduct a process, in which an alkane of a carbon number of 6-11 is used and its amount is set at 70 wt % or greater, for the purpose of optimizing the evaporation of the solvent during the application.

As long as it has an organic solvent composition containing an alkane as a major solvent, it is also possible to add and mix other alcohols, ethers, esters, fluorine-containing solvents, and aromatic solvents.

An alkane organic solvent usable in the present invention contains an alkane or cycloalkane as an essential solvent, such as pentane, isopentane, hexane, heptane, octane, nonane, decane, undecane, dodecane, tridecane, eicosane, docosane, cyclobutane and cyclohexane. It must be in 40 wt % or greater in all of the organic solvents. If it is less than 40 wt %, there occur problems that it corrodes the resist layer as substrate and that it extracts additives in the resist, from the resist. To be more preferable, it is possible to more perfectly suppress an interaction with the resist film as substrate, by using 70 wt % or greater of an alkane.

Since an alkane solvent of the present invention becomes a major solvent of spin coating, its boiling point range is important. In the present invention, hexane of a carbon number of 6 to undecane of 11 are preferable. The alkane may have a cyclic structure.

As a solvent that can be mixed with an alkane solvent of the present invention is exemplified, it is preferable to use alcohols such as butanol (normal, iso form and tertiary), methyl ethyl carbinol, pentyl alcohol, 3-pentyl alcohol, 2-pentyl alcohol, amyl alcohol, hexyl alcohol, heptyl alcohol, nonyl alcohol, octyl alcohol, pinacol, dimethyl propanol, 3-methyl-2-butanol, 2-methyl-2-butanol, cyclohexanol, ethylene glycol, and allyl alcohol; ethers such as diethyl ether, isobutyl methyl ether, and propylene glycol methyl ether; esters such as propylene glycol methyl ether acetate, ethyl acetate, and butyl acetate; ketones such as acetone and methyl isobutyl ester, and solvents in which fluorine has partially been substituted therefor. The partially-fluorine-substituted hydrocarbon solvents are specifically alkanes, alicyclic hydrocarbon solvents, hydrocarbonaceous alcohols. It is possible to use trifluoroethanol, tetrafluoroethanol and other fluorine-containing solvents, in which their hydrogen has partially been replaced with fluorine. By using fluorine, it is possible to effectively dissolve a polymer compound of the present invention and to conduct a coating that does not cause a damage to the resist film as substrate.

According to the present invention, it is possible to provide an effective top coat film forming process by a particular combination of an alkane of the major solvent with a minor solvent. As a particular combination used in the present invention, there is mixed 30 wt % or less concentration of an alcohol solvent having a boiling point higher than that of an alkane to be used. That is, as preferable combinations are specified, there are cited a case in which heptane is used as the alkane and hexyl alcohol is used as the alcohol solvent to be mixed, a case in which nonane is used as the alkane and hexyl alcohol and/or heptyl alcohol is used as the alcohol solvent to be mixed; and a case in which decane is used as the alkane and at least one selected from heptyl alcohol, octyl alcohol and nonyl alcohol is used as the alcohol solvent to be mixed.

According to the present invention, it is possible to previously add an additive, such as acid generator and quencher, to the top coat, for the purpose of minimizing the effect in case that an extract from the underlayer occurs. In particular, in case that an acid generator is added in the present invention, there occurs an effect of improving the resolution of the underlayer resist in immersion lithography.

Furthermore, it is possible to preferably use a hydrophobic additive for preventing the effect against water swelling and penetration, and an acid additive for accelerating solubility in the developing solution.

The top coat composition according to the present invention can be used without limitation on the underlayer resist type. That is, the underlayer resist can preferably be used, even though it is an arbitrary resist system such as negative type, positive type, composite type, single layer and double layer. Furthermore, it can be used, irrespective of various light sources such as 248 nm KrF excimer laser, 193 nm ArF excimer laser, vacuum ultraviolet region F2 laser represented by 157 nm, or an active energy ray such as electron beam and X-ray, which correspond to the recent trend of finer semiconductors. In particular, the top coat of the present invention is preferably applied in immersion lithography.

That is, in case that the present invention is used in a device production using immersion lithography, at first a solution of resist composition is applied by a spinner or the like to a support member such as silicon wafer or semiconductor production substrate, followed by drying, to form a photosensitive layer. The surface is covered with a top coat of a polymer according to the present invention by a spinner. After drying, it is immersed in water or the like, and it is irradiated with a laser light through a desired mask pattern. After heating this, a development treatment is conducted by using a developing solution, for example, an alkali aqueous solution such as 0.1-10 wt % tetramethylammonium hydroxide aqueous solution. With this, the top coat is fully dissolved by one development treatment, and at the same time the resist film of an exposed portion is dissolved, thereby leaving only the resist pattern by a single development.

In the following, the present invention is described by showing examples and comparative examples, but the present invention is not limited to the following examples.

### EXAMPLE 1

### Synthesis of Polymer Compound (A)

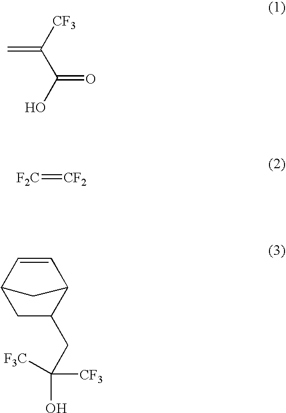

A 500 ml autoclave made of SUS was charged with 14 g of the above monomer (1), 27 g of the above monomer (3), 0.5 g of PERBUTYL D made by NOF CORPORATION as the initiator, 1 g of n-dodecylmercaptane, and 180 g of t-butanol, followed by replacement with nitrogen and then charging with 10 g of the above monomer (2). This was heated in an oil bath of 130° C. and stirred for 18 hr. After the termination of the reaction, the reaction solution was put into 1 liter of water/methanol (9/1), followed by stirring. The generated precipitate was filtered and taken out. Then, the precipitate was dissolved in isopropyl alcohol, followed by putting again into 1 liter of water/methanol (9/1) and then stirring. The generated precipitate was filtered and taken out. It was dried at 60° C. for 24 hr, thereby obtaining 21 g of Polymer Compound (A) in a white-color solid. The weight average molecular weight was determined by GPC (standard: polystyrene) to be 12,000.

### EXAMPLE 2

### Synthesis of Polymer Compound (B)

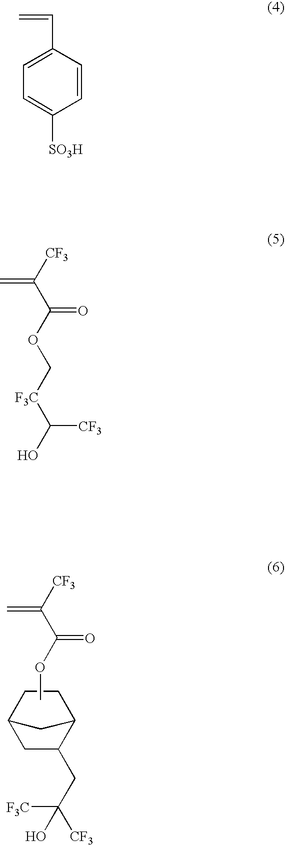

A 500 ml round-bottom flask equipped with a reflux condenser and a stirrer was charged with 10 g of the above monomer (4), 16 g of the above monomer (5), 22 g of the above monomer (6), 1.5 g of azobisisobutyronitrile (AIBN), 1.0 g of n-dodecylmercaptane, and 200 g of acetone, followed by replacement of the flask inside with nitrogen. This was heated in an oil bath of 75° C. and stirred for 18 hr. After the termination of the reaction, the reaction solution was put into 1 liter of water/methanol (9/1), followed by stirring. The generated precipitate was filtered and taken out. Then, the precipitate was dissolved in isopropyl alcohol, followed by putting again into 1 liter of water/methanol (9/1) and then stirring. The generated precipitate was filtered and taken out. It was dried at 60° C. for 24 hr, thereby obtaining 28 g of Polymer Compound (B) in a white-color solid. The weight average molecular weight was determined by GPC (standard: polystyrene) to be 8,300.

### EXAMPLE 3

### Synthesis of Polymer Compound (C)

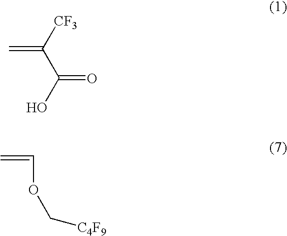

A 500 ml round-bottom flask equipped with a reflux condenser and a stirrer was charged with 21 g of the above monomer (1), 41 g of the above monomer (7), 1.6 g of azobisisobutyronitrile (AIBN), 1.0 g of n-dodecylmercaptane, and 200 g of acetone, followed by replacement of the flask inside with nitrogen. This was heated in an oil bath of 75° C. and stirred for 18 hr. After the termination of the reaction, the reaction solution was put into 1 liter of water/methanol (9/1), followed by stirring. The generated precipitate was filtered and taken out. Then, the precipitate was dissolved in isopropyl alcohol, followed by putting again into 1 liter of water/methanol (9/1) and then stirring. The generated precipitate was filtered and taken out. It was dried at 60° C. for 24 hr, thereby obtaining 25 g of Polymer Compound (C) in a white-color solid. The weight average molecular weight was determined by GPC (standard: polystyrene) to be 9,800.

### EXAMPLE 4

### Synthesis of Polymer Compound (D)

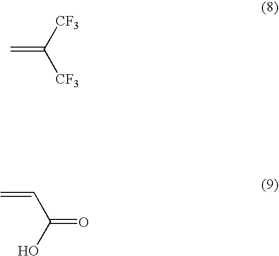

A 500 ml round-bottom flask equipped with a reflux condenser and a stirrer was charged with 24.6 g of the above monomer (8), 10.8 g of the above monomer (9), 1.6 g of azobisisobutyronitrile (AIBN), 1 g of n-dodecylmercaptane, and 200 g of acetone, followed by replacement of the flask inside with nitrogen. This was heated in an oil bath of 75° C. and stirred for 18 hr. After the termination of the reaction, the reaction solution was put into 1 liter of water/methanol (9/1), followed by stirring. The generated precipitate was filtered and taken out. Then, the precipitate was dissolved in isopropyl alcohol, followed by putting again into 1 liter of water/methanol (9/1) and then stirring. The generated precipitate was filtered and taken out. It was dried at 60° C. for 24 hr, thereby obtaining 25 g of Polymer Compound (D) in a white-color solid. The weight average molecular weight was determined by GPC (standard: polystyrene) to be 14,000.

### EXAMPLE 5

### Synthesis of Polymer Compound (E)

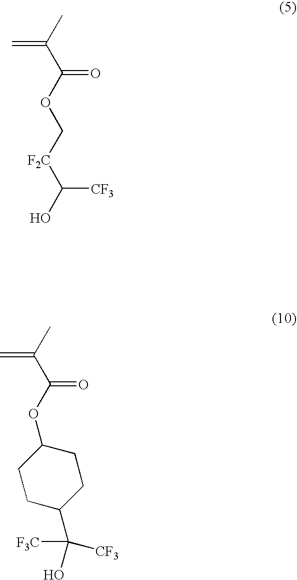

A 500 ml round-bottom flask equipped with a reflux condenser and a stirrer was charged with 20 g of the above monomer (5), 30 g of the above monomer (10), 1.6 g of azobisisobutyronitrile (IBN), 1 g of n-dodecylmercaptane, and 200 g of acetone, followed by replacement of the flask inside with nitrogen. This was heated in an oil bath of 75° C. and stirred for 18 hr. After the termination of the reaction, the reaction solution was put into 1 liter of water/methanol (9/1), followed by stirring. The generated precipitate was filtered and taken out. Then, the precipitate was dissolved in isopropyl alcohol, followed by putting again into 1 liter of water/methanol (9/1) and then stirring. The generated precipitate was filtered and taken out. It was dried at 60° C. for 24 hr, thereby obtaining 38 g of Polymer Compound (E) in a white-color solid. The weight average molecular weight was determined by GPC (standard: polystyrene) to be 4,800.

### REFERENTIAL EXAMPLE

In accordance with the process of Example 2, a standard ArF resist polymer was synthesized by using three components of ethyladamantane methacrylate (EAD), hydroxyadamantane methacrylate (HAD), and butyrolactone methacrylate (GBL) to obtain Polymer Compound (F) suitable for ArF excimer laser. The molar composition of the three components was found by the measurement with NMR to be EAD42/HAD30/GBL28. The weight average molecular weight was determined by GPC (standard: polystyrene) to be 16,000.

Then, Polymer Compound (F) was dissolved in propylene glycol methyl acetate, and the solid content was adjusted to 10 wt %. Furthermore, triphenylsulfonium triflate (TPS105) made by Midori Chemical as an acid generator was dissolved in 2 parts by weight relative to 100 parts by weight of Polymer Compound (F), thereby preparing a resist solution.

### EXAMPLES 6-12

The polymer compounds produced by Examples 1-5 were dissolved in mixed solvents (the numerals are in wt %) shown in Table to have a solid matter concentration of 4.5 wt % and to obtain top coat liquids of Examples 6-12. Solubilities were good, and solubilities have not changed even two days later.

Then, the photoresist solutions prepared by Reference Example were applied to silion wafers by spin coating at 1,500 rpm for 60 seconds, followed by drying at 110° C. for 60 seconds, thereby obtaining resist films of a thickness of about 180 nm.

Furthermore, the polymer solutions of Table obtained by Examples 6-12 were applied to the above photoresist films by spin coating to have a thickness of about 45 nm, followed by baking at 110° C. for 50 seconds, thereby obtaining uniform top coat films on the resist films. These two-layer films were immersed in 2.38 wt % tetramethylammonium hydroxide aqueous solution for 60 seconds. With this, only the top coat film of the upper layer was rapidly dissolved, and only the original photoresist film was left.

TABLE

| | | | | | | TMAH |
|---|---|---|---|---|---|---|
| | Polymer | Solvent 1 | Solvent 2 | Solvent 3 | Solubility | Solubility |
| Example 6 | A | Hexane | Heptyl alcohol | None | Good | Good |
| | | 40 wt % | 60 wt % | | | |
| Example 7 | B | Nonane | Octyl alcohol | Butanol | Good | Good |
| | | 70 wt % | 25 wt % | 5 wt % | | |
| Example 8 | C | Heptane | Octyl alcohol | None | Good | Good |
| | | 80 wt % | 20 wt % | | | |
| Example 9 | D | Heptane | Butyl alcohol | None | Good | Good |
| | | 80 wt % | 20 wt % | | | |
| Example 10 | E | Decane | Octyl alcohol | None | Good | Good |
| | | 90 wt % | 10 wt % | | | |
| Example 11 | A | Heptane | Hexyl alcohol | Amyl alcohol | Good | Good |
| | | 60 wt % | 30 wt % | 10 wt % | | |
| Example 12 | E | Decane | Octyl alcohol | None | Good | Good |
| | | 75 wt % | 25 wt % | | | |
| Com. Ex. 1 | A | Hexane | Heptyl alcohol | None | Good | Good |
| | | 30 wt % | 70 wt % | | | |
| Com. Ex. 2 | E | None | Octyl alcohol | None | Good | Good |
| | | | 100 wt % | | | |

### COMPARATIVE EXAMPLES 1-2

Similar to Examples 6-12, Polymer Compounds (A) and (E) were dissolved in mixed solvents (the numerals are in wt %) shown in Table to have a solid concentration of 4.5 wt %, thereby obtaining top coat liquids of Comparative Examples. The solubilities were good, and the solubilities did not change even two days later.

Then, the photoresist solutions prepared by Reference Example were applied to silion wafers by spin coating at 1,500 rpm for 60 seconds, followed by drying at 110° C. for 60 seconds, thereby obtaining resist films of a thickness of about 180 nm.

Furthermore, the polymer solutions of Table obtained by Comparative Examples 1-2 were applied to the above photoresist films by spin coating to have a thickness of about 45 nm, followed by baking at 110° C. for 50 seconds, thereby obtaining uniform top coat films on the resist films. These two-layer films were immersed in 2.38 wt % tetramethylammonium hydroxide aqueous solution for 60 seconds. With this, the top coat film of the upper layer was rapidly dissolved, but the apparent film thicknesses of the resist films have increased in Comparative Example 1 and 2, and swelling phenomena were found.

### EXAMPLES 13-19

The polymer solutions obtained by Examples 6-12 were applied to the photoresist films obtained by Referential Example by spin coating to have a thickness of about 40nm, followed by baking at 110° C., thereby obtaining two-layer films. The two-layer films were covered with pure water of a thickness of 1 mm. They were exposed to ultraviolet rays by using a high pressure mercury lamp above the water surface through a photomask, followed by removal of the pure water and then a post exposure baking at 130°C. Then, a development was conducted at 23° C. for 1 minute by using 2.38 wt % tetramethylammonium hydroxide aqueous solution. As a result of this, in each case, the top coat film was fully dissolved, and at the same time the exposed portion of the resist film was dissolved. Only the unexposed portion of the underlayer was left in a rectangular pattern form.

### COMPARATIVE EXAMPLES 3-4

The polymer solutions obtained by Comparative Examples 1-2 were applied to the photoresist films obtained by Referential Example by spin coating to have a thickness of about 40nm, followed by baking at 110° C., thereby obtaining two-layer films. The two-layer films were covered with pure water of a thickness of 1 mm. They were exposed to ultraviolet rays by using a high pressure mercury lamp above the water surface through a photomask, followed by removal of the pure water and then a post exposure baking at 130° C. Then, a development was conducted at 23° C. for 1 minute by using 2.38 wt % tetramethylammonium hydroxide aqueous solution. As a result of this, in each case, the top coat film was fully dissolved, and at the same time the exposed portion of the resist film was dissolved. Although a resist pattern was obtained, its form was a T-top form.

1. A process for producing a top coat film used in a lithography, comprising the steps of:
(a) providing a polymer that dissolves in an alkali developing solution, the polymer having in the molecule at least one group that is optionally protected and that is selected from the group consisting of a fluorocarbinol group, a sulfonic acid group, a fluoroalkylsulfonic acid group, and a carboxylic group;
(b) dissolving the polymer in an organic solvent containing 40 wt % or greater of an alkane, thereby preparing a coating composition; and
(c) applying the coating composition to a photoresist film, thereby forming the top coat film on the photoresist film.

2. A process according to claim 1, wherein the organic solvent of the step (b) contains 70 wt % or greater of the alkane, and the alkane has a carbon atom number of 6 to 11.

3. A process according to claim 1, wherein the organic solvent of the step (b) further contains 30 wt % or less of an alcohol having a boiling point higher than that of the alkane.

4. A process according to claim 1, wherein the polymer of the step (a) is a fluorine-containing polymer.

5. A process according to claim 4, wherein the fluorine-containing polymer has a weight average molecular weight of 1,5000 or less and a fluorine content of 20 wt % or greater.

6. A process according to claim 3, wherein the alkane is heptane, and the alcohol is at least one of hexyl alcohol and heptyl alcohol.

7. A process according to claim 3, wherein the alkane is nonane, and the alcohol is at least one of hexyl alcohol and heptyl alcohol.

8. A process according to claim 3, wherein the alkane is decane, and the alcohol is at least one selected from the group consisting of heptyl alcohol, octyl alcohol, and nonyl alcohol.

9. A process according to claim 1, wherein the lithography is an immersion lithography.

10. A process according to claim 1, wherein the group of the polymer has at least one terminal acid moiety represented by at least one of the following formulas, 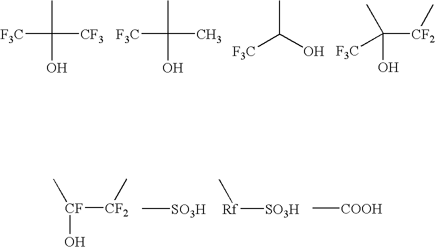
wherein Rf is a fluoroalkyl group.

11. A process according to claim 1, wherein the polymer of the step (a) comprises a repeating unit derived from at least one monomer represented by the following formulas, 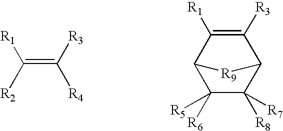
wherein at least one of R₁ to R₉ is a group comprising at least one acid group that is optionally protected, and each of the rest of R₁ to R₉ is an atom or group.

12. A process according to claim 1, wherein the polymer of the step (a) comprises a repeating unit derived from first, second and third monomers respectively represented by the following formulas (1), (2) and (3).

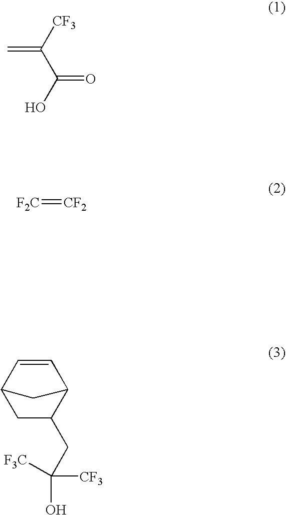

13. A process according to claim 1, wherein the polymer of the step (a) comprises a repeating unit derived from first, second and third monomers respectively represented by the following formulas (4), (5) and (6).

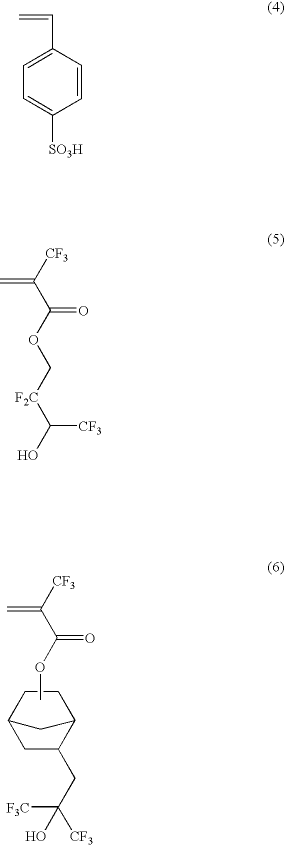

14. A process according to claim 1, wherein the polymer of the step (a) comprises a repeating unit derived from first and second monomers respectively represented by the following formulas (1) and (7).

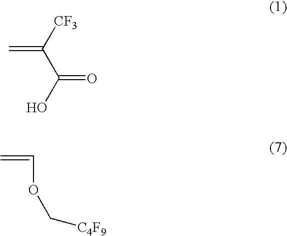

15. A process according to claim 1, wherein the polymer of the step (a) comprises a repeating unit derived from first and second monomers respectively represented by the following formulas (8) and (9).

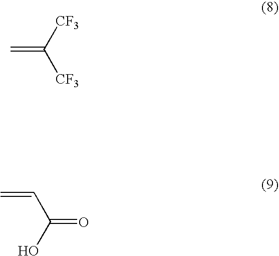

16. A process according to claim 1, wherein the polymer of the step (a) comprises a repeating unit derived from first and second monomers respectively represented by the following formulas (5) and (10). [chemical structure]
